(19) United States
(12) Patent Application Publication
(10) Pub. No.: US 2001/0010537 A1
(43) Pub. Date: Aug. 2, 2001

(54) DEVICE FOR PROJECTION ONTO A DOME

(76) Inventors: WILFRIED LANG, COSPEDA (DE); LUDWIG MEIER, JENA (DE)

Correspondence Address: REED SMITH LLP, 375 PARK AVENUE, NEW YORK, NY, 10152, US

(21) Appl. No.: 09/029,704

(22) PCT Filed: Jul. 4, 1997
(86) PCT No.: PCT/EP97/03553

§ 371 Date: None

(30) Foreign Application Priority Data
Jul. 15, 1996 (DE) 196 28 455.4

(51) Int. Cl. H04N 7/00

(52) U.S. Cl. 348/36

(57) ABSTRACT

In a device for projection on a dome with a plurality of projectors (50, 51, 54, 56) for displaying image contents on an at least partially spherical projection surface (52), wherein every projector (50, 51, 54, 56) is arranged in such a way that it illuminates at least a partial surface (56, 58) of the projection surface (52) with partial images, and there is provided for at least for one of the projectors (51, 54, 56) a light source (12) and a deflecting device (40) by which a light bundle (10) emitted from the light source (12) can be guided along the portion to be illuminated in order to display the image contents, the deflecting device (40) of the at least one projector (51, 54, 56) is constructed as a scanning device by which the light bundle can be guided in a plurality of lines with a plurality of picture points over the partial surface (56, 58) to be illuminated, and the light source (12) is connected to an intensity control (64) on the basis of which individual picture points can be illuminated for displaying the partial image (56, 58) with suitable luminous density. (FIG. 2)

The invention is directed to a device for projection on a dome with a plurality of projectors for displaying image contents on an at least partially spherical projection surface, wherein every projector is arranged in such a way that it illuminates at least a partial surface of the projection surface with partial images, and wherein there is provided for at least for one of the projectors a light source and a deflecting device by which a light bundle emitted from the light source can be guided along the portion to be illuminated in order to display the image contents.

A device of this kind is known from the planetarium in the “Forum der Technik” in Munich. One of the projectors is a starball which is located in the center of the hemispheric room and is used to project stars on the dome. Other projectors are used for showing additional information such as planet images or star images. Further, projectors are also provided with light sources in which the bundle exiting from a light source is guided rapidly over parts of the dome. Vector graphics which are used especially for show applications in the planetarium to display stereo images are generated by means of these projectors.

This outfitting of a planetarium results in an entirely new medium for light and sound shows which have already attracted large audiences in the experimental stage with simple shows such as “Cosmic Dreams” in the Forum der Technik.

The projection of images with light bundles for color video display is known from Funkschau 1970, Volume 4, page 96. In order to display color images, three laser beams of different wavelengths are bundled and combined in a single beam. The combined beam is subsequently scanned over a screen by means of mirror arrangements for sequential illumination of image points of the displayed image, so that an image is generated similarly as in the screen of a television tube, but with light bundles instead of electron beams.

A laser planetarium by Zytel Laser Systems Ltd., Winnipeg, which was already operated with such a scanning technique in 1972 is described in the book “Der Himmel auf Erden - Die Welt der Planetarien [Heaven on Earth, the World of Planetaria]”, by Ludwig Meier, Verlag Johann M. Ambrosius Barth, Leipzig, Heidelberg, 1992, page 71. In this planetarium, lasers were controlled by means of a computer. The laser beams for every color were deflected by small mirrors. Further, a fisheye lens was provided which expanded the angular region that could be accessed by the mirrors so that the entire planetarium dome could be covered by scanning.

These first attempts to cover a planetarium dome with scanning light bundles was abandoned, however, since high frequency in the gigahertz range is needed at the required resolution of 75 million pixels in the dome and a 25-times coverage in one second for lighting up individual stars. The technical problems involved in this were insurmountable in that the limit of physical possibilities was confronted. Therefore, laser application is presently restricted exclusively to vector graphics for show applications.

For this purpose, there are laser projectors for the stereoscopic display of vector graphics such as those indicated, for example, in DE 41 25 241 A1. It is stated in this reference that other image displays such as the display of video images, for example, are not possible with lasers because they are based on a flat image display with a one-time illumination of every point of the image surface per image.

This patent application was filed on Jul. 26, 1991, which means that no progress was made for twenty years with regard to the previously known prior art from the seventies for scanning image display in large rooms such as planetarium domes.

At present, a substantial difficulty with regard to the projection of images consists in the generation of a sufficiently high luminous density. Given a spectator space of equal size, a hemispherical surface to be covered by a projector is substantially greater than a conventional cinema screen, for example. Therefore, in order to project an image in a dome using conventional film projection methods one resort has been to carry out independent projection in individual contiguous screen segments from which a total image is formed. However, the films used in such cinema presentations have a very large format due to the high illumination density and the consequent thermal loading. In spite of the large, hard-to-manage film format, currently used dome projectors always require elaborate cooling measures.

For this reason, this type of projection has not be introduced before in planetaria or in cinema technology for the display of a two-hour film, for example, with the exception of isolated instances such as projection arrangements at festivals in which only short films are offered at a commensurate price.

When projecting on a dome by means of a plurality of partial images, problems arise for reasons pertaining to geometry with respect to dividing up a spherical surface into a plurality of image segments. It is not possible to show a planar image on a curved surface without distortion. Further, there are always overlapping areas when projecting partial images, for example, when the projected image is bounded by straight edge areas. This problem can be solved in that the image to be projected is presented in a distorted manner on the film itself, for example, in order to compensate for the inevitable geometric distortions, wherein the image contents in the overlapping area are cut out.

This technique requires specially processed films for dome projection. This also represents a cost factor which has so far restricted commercial utilization of film presentations in domes.

In the above-mentioned book, “Der Himmel auf Erden - Die Welt der Planetarien”, Ludwig Meier, a dome projection is described on pages 65 to 67, wherein the dome is filled with content by projecting an individual film. A fisheye lens is used to illuminate the partially spherical screen. However, this type of projection results in insurmountable distortions at the edge of the image. Because of the high thermal loading of the film by 12,000-Watt arc lamps, the large-format 70 mm film must be cooled. Moreover, the special production of a film with a running time of 30 minutes would mean a cost in the region of several million U.S. dollars.

For the purpose of economical management of distortions in the primary projected image, there are suggestions for image processing by means of computer which are detailed on pages 70 ff. of the above-mentioned book. Pages 71-75, for example, relate to a planetarium in which stars are shown on a picture tube in an electronically controlled manner. Cinema films could also be projected on a dome in the same manner with a system of this kind. However, current computer performance for distortion of the image so that these images can be projected on the dome via the fisheye lens so as to be restored to their geometrically correct state are inadequate. Further, the luminous density is not adequate for large domes with diameters of several meters.

As was already mentioned, it is suggested in this regard on pages 70-71 of the above-mentioned book to display images with lasers by scanning on the curved screen as in the example of electron beam tubes. Experiments in this direction have also not led to commercial success due to the low available laser output, the required high writing speed on the screen, and the resulting poor resolution taking into account conventional switching speeds for controlling intensity.

For smaller partially spherical surfaces, on the other hand, a laser device of the type mentioned above is known from U.S. Pat. No. 4,297,723, in which an image is displayed on a partially spherical screen surface in three separate sectors by scanning. To display the image in the image segments illuminated by three partial images, three light bundles are combined by means of a mirror system, directed by optics onto a raster scanning device jointly shared by all of the partial images, and then separated again by means of further optics and subsequently deflected onto a screen in the individual image segments by additional expansion optics. The additional expansion optics again comprise mirrors in an arrangement which exclusively allows a maximum of 3 partial surfaces to be filled with the desired image contents. This is not sufficient for complete coverage of a planetarium dome.

Other projections in the planetarium are carried out by means of special projectors working with transparencies. In particular, the known planet projectors used in planetaria are mentioned in this connection. With these projectors, special mechanisms are required for displaying different planetary movements or for demonstrating phases of the moon. The more natural the display of celestial phenomena, the more costly the mechanisms employed. For example, an additional zoom lens is required for displaying the apparent enlargement of the moon on the horizon. Further, mechanisms are required for the automatic control of focussing at different distances of the objective from the dome during the path-controlled movement of planet images.

The examples show that such projectors are very complicated and projectors with programmable image contents are desired for this purpose. In the present state of the art for planetarium projection given by the above-mentioned electron beam images, a mechanism is still required for tracking or adjusting moving images such as moon images and planet images. When the projectors are situated outside of the center, the focus must also always be adjusted during the movement of the images over the dome because of the varying distance from the dome. Laser projectors with an almost parallel light bundle do not have this disadvantage, but their current field of used is exclusively that of vector graphics, as was mentioned. However, images of planetary or lunar phases can not be displayed at all in this way.

It is the object of the present invention to provide a device which has a substantially simpler construction than previous planetaria with respect to projection technique, requires fewer mechanical devices, but which nevertheless enables a substantially increased image quality compared with vector graphics.

Based on the prior art mentioned above, this object is met in that the deflecting device of the at least one projector is constructed as a scanning device by which the light bundle can be guided in a plurality of lines with a plurality of picture points over the partial surface to be illuminated, and the light source is connected to an intensity control, on the basis of which individual picture points can be illuminated for displaying the partial image with suitable luminous density.

Thus, the laser projector used in the invention has been known from television technology since 1970. However, developments for dome projection, especially in planetaria, have not previously led to the use of such projectors. Rather, development pursued a different course and laser projectors were used in planetaria only for vector graphics. Consequently, prior developments did not lead to a successful outcome because it was attempted to illuminate the entire dome with one scanning device, which was doomed to failure due to the low resolution brought about for that reason, especially because it was attempted during that time to display the starry sky itself with lasers, which requires an extremely high resolution for a true-to-nature imaging.

The laser projector known from U.S. Pat. No. 4,297,723 is suitable only for flight simulation and it can only display images within a limited surface region. The invention differs from this in that there is provided a plurality of projectors with their own individual deflecting device for every light source, each of which illuminates only a partial surface. This provides substantially greater flexibility for the display of large image contents by combining a plurality of projectors. By means of combining a plurality of these projectors, the entire dome can even be filled with image contents, in principle, in that the dome is divided into partial surfaces and each of these partial surfaces is given its own scanning laser projector.

A correspondingly high resolution can also be provided in principle for displaying the starry sky, given a corresponding number of projectors.

On the other hand, costs are further reduced when the high resolution in laser projectors is dispensed with and a starball is provided for projecting the starry sky in accordance with a preferable further development of the invention.

A starball such as that used in the planetarium at the “Forum der Technik” comprises a central projection unit in which a plurality of glass fibers provide for a high luminous density in the star plates to be projected. The scanning laser projectors can then have a lower resolution and can be used solely for the purpose of projecting additional image content in the dome. This image content includes, for example, the projection of a panorama, the display of planets, moons and their movements, solar eclipses, lunar eclipses, and the like images.

The geometry problem of overlapping regions is solved in that the scanning devices of a plurality of projectors having the light source, the scanning device and the intensity control are arranged concentrically around the starball and/or in the vicinity of the periphery, wherein a plurality of polygonal partial surfaces can be illuminated by these projectors, these polygonal partial surfaces being bordered on at least two sides by segments of large circles and/or parallel circles of the dome. In this way partial surfaces can be illuminated in the familiar manner similar to the peeling of the skin off an orange, for example.

Rectangular or triangular partial surfaces which are bordered on at least two sides by portions of large circles and parallel circles of the dome are adequate for displaying, for example, planetary movements, lunar phases or the like which can be displayed in defined surface regions without any overlapping of the partial surfaces. In particular, the panorama of a city can be reproduced in the lower dome region by means of partial surfaces which are bordered by parallel circles and large circles on the horizon of a planetarium.

The problem of overlapping mentioned above is solved, in accordance with an advantageous further development of the invention, in that a plurality of partial surfaces can be illuminated by a plurality of these projectors with scanning devices, in that at least one of these projectors has at least one scanning device which enables the illumination of a region of the projection surface which is larger than the partial surface to be illuminated by this projector, and in that the light source can be faded and, in particular, hidden or blanked by means of the intensity control when scanning in the larger region outside of the partial surface to be illuminated.

According to this further development of the invention, the problem of overlapping is solved in that the scanned areas that are larger than the partial surface with which the surface of the dome or partial dome is covered are defined in that the edge of these partial surfaces is blanked in the overlapping area. This results in a neat joining of different adjacent partial surfaces to be illuminated by projectors. However, it is recommended after adjustment only to fade the edges (soft edge principle) so that the gaps do not disturb, wherein, however, the sum of the light intensities in the edge area is adapted to the light intensity in the central area of the partial surfaces.

In another preferred further development of the invention, a light-conducting fiber is provided between the scanning device and the light source and a movement device is provided by which the scanning device is movable independent from the light source.

According to this further development, planet projectors can be constructed in a very simple manner. In the prior art, a very heavy projector had to be moved very precisely. In this further development, the lighter scanning device is uncoupled from the rest of the components of the projection system. This projection system can be moved with substantially less effort. Further, the problems of depth of field and adjusting sensitivity are eliminated. The further development thus simplifies planet projectors and lunar projectors especially.

But this further development is also advantageous for the arrangement of dome projection by means of a plurality of projectors for illuminating contiguous partial surfaces. In this case, the movement device can be used for adjusting the two contiguous partial surfaces relative to one another so as to enable a continuous overlapping of the illumination of the dome.

According to another preferred further development of the invention, the movement device is designed for independent movements in at least two directions. In this way, planets can be guided along the dome. Two angular movements are sufficient for this purpose according to familiar spherical coordinates.

According to a preferred further development, the movement device is controllable by means of a control device for at least one programmed movement sequence of the partial image illuminated by the at least one projector. This programmability makes use of the fact that the planetary movement always follows similar function curves which are given by celestial mechanics and which can be parameterized. The programmability of such functions relieves the control device of the burden of control processes for the movement in that only orbital parameters need to be given to the movement device and this movement device then lets the desired movement be executed automatically. Additional computing time is then available, insofar as the control device is a computer or contains a computer, for example, for calculating rectifications for the displayed images.

Consequently, in a preferred further development of the invention, movements of partial images on the projection surface can be carried out on the basis of programmed movement sequences in large circles or for theoretically calculated planetary orbits.

As was already mentioned in detail, the light sources are preferably lasers. As is conventional, these lasers emit light bundles with a dominant wavelength. As a rule, this is not critical when the wavelengths for different planets are selected according to the color of the planet. However, for the purpose of simplification, the color can be programmed in a simple manner, since the same projector can be used for different planets when the light source of the at least one projector outfitted with a scanning device is controllable, according to a preferred further development of the invention, for a color display of the partial image for emitting a light bundle containing light with at least three different wavelengths.

According to a further preferred development of the invention, the light source for emitting the light bundle containing light with at least three different wavelengths has a laser for each of these wavelengths, each laser being connected to a control device for controlling intensity, by means of which the color of the light bundle can be controlled for different image points of the partial surface. Color images can accordingly also be displayed. For example, the planet Earth can be projected as a large image with details showing bodies of water, clouds and land masses.

Further, the devices mentioned above, also in accordance with the further developments, have great advantages for the planetarium with respect to the space requirement in the dome. All of the three different types of image contents to be displayed in a planetarium can be projected with the projectors described above. The first type of image content is that extending over the entire dome, the second type covers a circular region, as in panoramic pictures, and the third covers a small surface of up to approximately 30×30 angular degrees, but is movable over the dome in a controlled manner. With the latter type, in particular, an all-purpose projector can be used for displaying the sun, moon and planets in front of the starry sky displayed by a fiber-optic starball. The special transparency type projector required in the prior art with all of the mechanisms for displaying phases, the zoom lens mechanism, and the devices for automatically controlled focussing of the image are replaced by an easily movable scanning head which contains exclusively the deflecting device and to which the light is guided via a light-conducting fiber. The projector part to be moved, that is, the scanning head, is smaller and more flexible than the projectors known from the prior art. The display is more extensive and an improved image quality can even be realized.

The invention is explained more fully hereinafter with reference to the drawings.

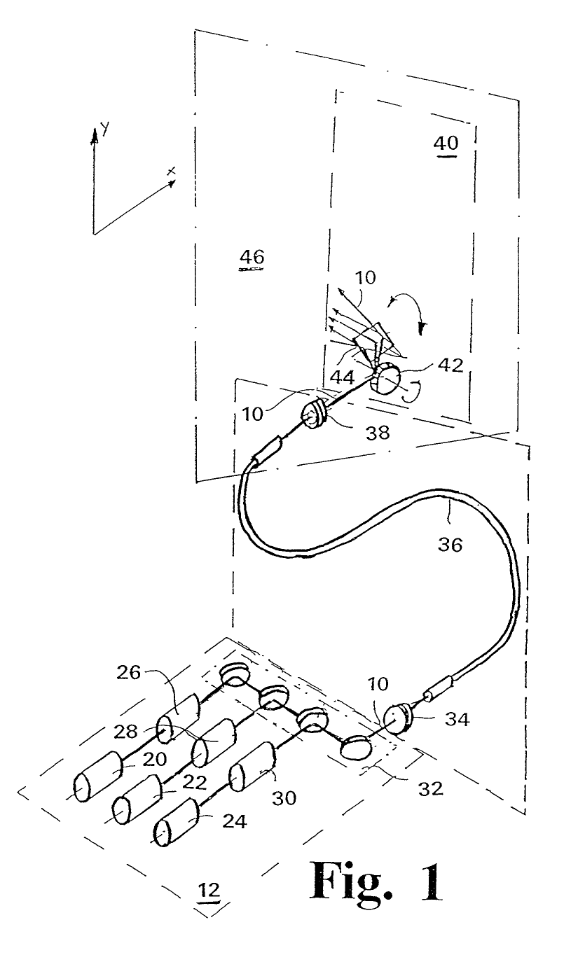

FIG. 1 illustrates the principle of a laser projector shown in a planet projector;

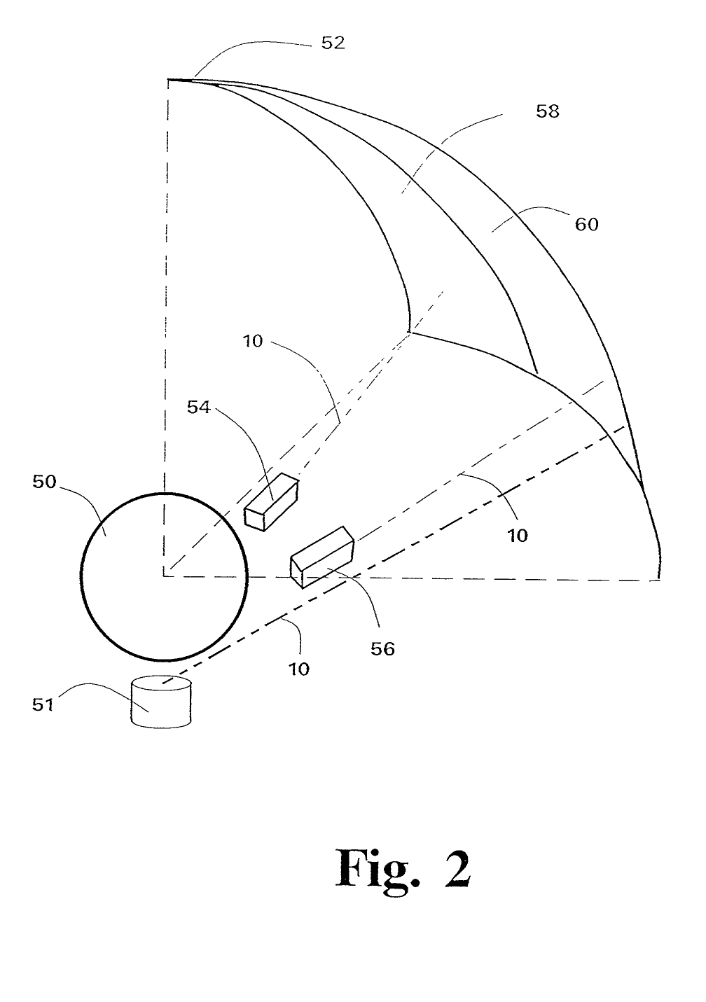

FIG. 2 is a schematic view of the arrangement of projectors relative to a starball in a planetarium;

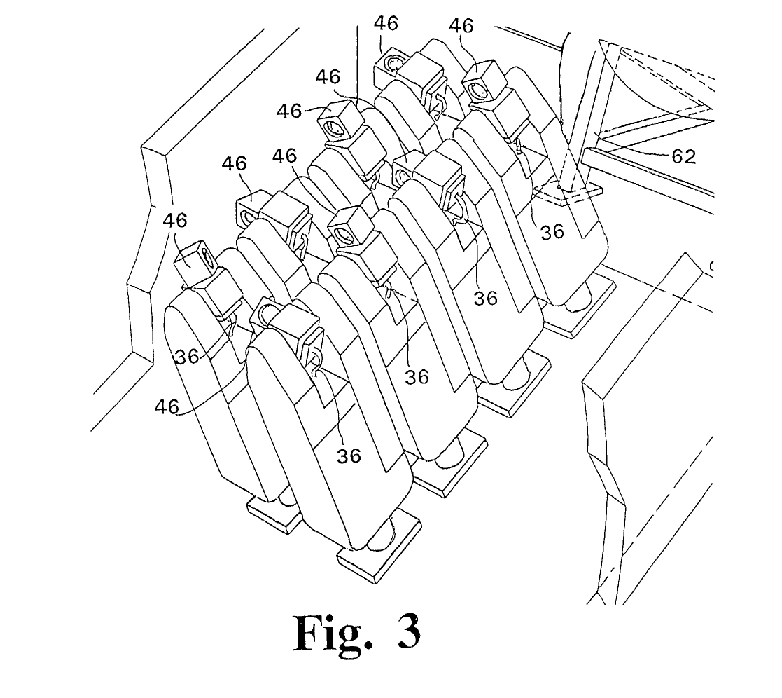

FIG. 3 shows the arrangement of scanning heads of planet projectors in the vicinity of a starball;

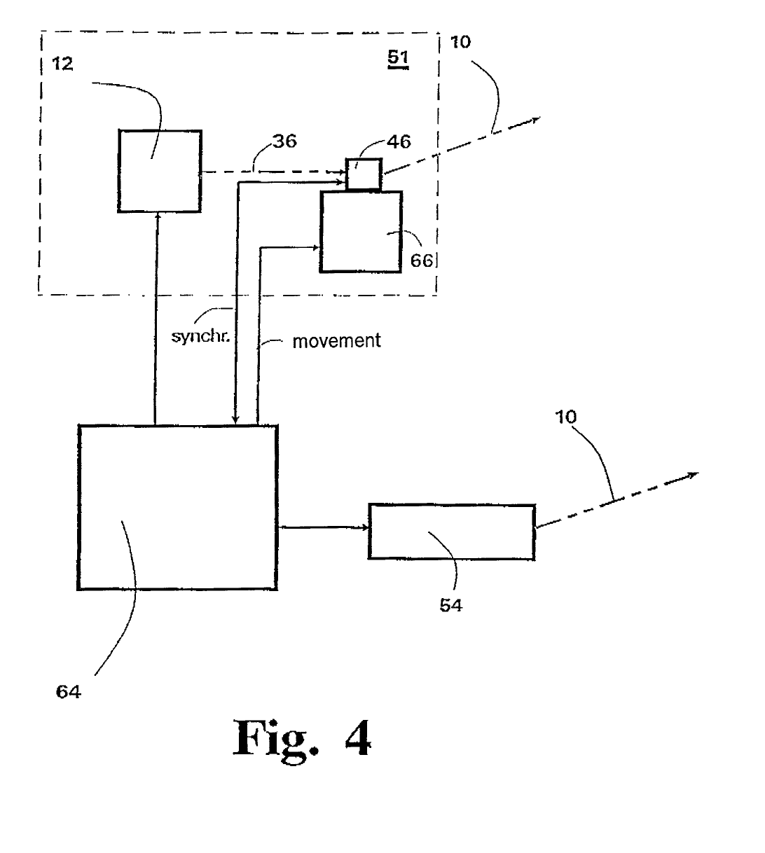

FIG. 4 is a schematic view showing the controlling of the projectors.

In FIG. 1, the principle of a projector which works with scanned light bundles is explained more fully. A light bundle 10 is generated by means of a light source 12. The light source 12 contains gas lasers 20, 22, 24 in the embodiment example. The lasers 20, 22, 24 used for this purpose are statically operated and their intensity is controlled by means of separate devices such as the modulators 26, 28, 30 in the embodiment example. Separate modulation is not required when using semiconductor lasers because the laser beam in this case is directly controllable in intensity with sufficient speed via the supplied output.

In the embodiment example, three lasers 20, 22, 24 are used, all of which emit at different wavelengths to generate a red, a green and a blue beam for illuminating an image point. The color of an image point is mixed by corresponding control of the modulators 26, 28, 30. The colors of the planets can be imaged true-to-nature by means of the mixed colors.

The three light bundles which are emitted by the laser and subsequently modulated are combined via a mirror system 32 into a common light bundle 10. Dichroitic mirrors are used for this mirror system 32. Compared with partially transparent mirrors which would also enable a combination in a manner similar to that shown in FIG. 1, dichroitic mirrors have the advantage that the total intensity of the light bundles generated by the lasers and subsequently modulated is available for illuminating image points. In the case of semitransparent mirrors, on the other hand, an output loss due to reflection in unsuitable directions must be taken into account.

The light bundle 10 is subsequently coupled into a light-conducting fiber 36 by means of incoupling optics 34 and, after exiting the light-conducting fiber 36, is bundled again by outcoupling optics. This bundled light bundle is directed into a scanning device 40 in which a polygon mirror and a swivel mirror are substantially provided for scanning. The rotating polygon mirror 42 serves for deflection in the x-direction and the swivel mirror 44 serves for deflection in the y-direction. The light bundle 10 is accordingly guided over the projection surface, not shown in FIG. 1, in the manner of an electron beam in the known television tube. The image points which are illuminated sequentially during the scanning are color-controlled and intensity-controlled via the modulators 26, 28, 30 so that an image is formed in a manner analogous to television.

Compared with conventional projectors for displaying an image in a dome, however, the projection system shown in FIG. 1 differs in that focussing is not necessary even at varying distances from the different partial surface of the dome because the sharpness of the image point depends exclusively upon the parallelism of the laser beam.

The light-conducting fiber 36 thus proves advantageous in planet projectors when the image of a planet is not held statically in one position, but is also guided over the surface of the dome. For this purpose, the end of the light-conducting fiber with the outcoupling optics 38 is rigidly connected with the input of the scanning device 40. The resulting unit is swiveled in two directions for displaying planetary movements as will be explained more clearly hereinafter with reference to FIG. 3. Since only the rigid unit, namely this scanning head 46, is moved independently from the light source 12, the required mechanical apparatus is substantially reduced in comparison to the prior art in which a heavy projector had to be moved. Distortions due to different projection surface regions during movement are compensated by modulation by means of the modulators 26, 28, 30 with different image contents depending on the location or angular position of the scanning head 46. A control device 64, described hereinafter, which controls the movement of the scanning head 46 as well as the modulation via modulators 26, 28, 30 is provided for this purpose.

The light-conducting fiber 36 can be dispensed with for other projectors which are also usable in the planetarium, for example, for displaying a panorama, because a movable coupling of the scanning head to the light source 12 is not absolutely necessary in this case. However, the possibility of adjustment with respect to the illuminated partial surfaces should also be provided in such panorama projectors. It is also possible in this case to uncouple the light source 12 from the scanning head 46 by means of a light-conducting fiber 36 so that only the scanning head 46 need be moved for the purpose of adjustment.

FIG. 2 is a schematic view showing the construction of a planetarium. The starry sky is displayed on a dome 52 by means of a starball 50 known from the prior art. It is possible to project the starry sky on the dome with the required high resolution and intensity by means of the starball 50.

The starball 50 is centrally arranged in the planetarium shown in FIG. 2, so that, by means of rotating the starball 50 about its center, the different starry skies at different latitudes and times of year can be displayed or different constellations can be displayed for the northern and southern hemispheres.

In FIG. 2, a planet projector constructed in a manner similar to that shown in FIG. 1 is designated by 51. This planet projector 51 is arranged in the vicinity of the starball and makes it possible to display partial images of 30×30 angular degrees on the dome 52. This planet projector 51 again has a movable scanning head 46 which is also separated from the light source 12 by a light-conducting fiber 36 so that this projectable surface of 30×30 degrees can be moved over the dome 52. Because of this, the movement of the displayed planets and their positions in every season can be shown in the planetarium.

Further, panorama projectors 54 and 56 are arranged concentrically about the starball 50. The projectors which are shown schematically and provided with reference numbers 54 and 56 are shown in FIG. 2 only by way of example. Actually, in the embodiment example, the entire starball 50 is surrounded concentrically at given angular steps, especially at equal angular steps in the embodiment example, by these projectors. However, the dimensional ratios are not given exactly in FIG. 2 for the sake of improved clarity. In the embodiment example, the panorama projectors are located substantially closer to the starball 50 and are at a greater distance from the dome 52 than is shown schematically in FIG. 2.

Image contents which are defined surfacewise are reproduced in partial surfaces 58 and 60 by means of the panorama projectors 54 and 56. The image contents of adjacent panorama projectors 54 and 56 supplement one another so as to enable the display of a total image with improved resolution on the dome 52, which total image is substantially larger than if only an individual projector were provided for displaying the entire panorama.

The skyline of a city, for example, can be projected with these panorama projectors 54 and 56. Further, other events in space can be displayed by means of such projectors, for example, a docking maneuver of space ships. However, every partial surface 58 and 60 must extend to a greater height in contrast to simple projection of a panoramic city skyline.

The partial surfaces, two of which, 58 and 60, are shown by way of example, are delimited, for the purpose of dividing the dome into segments, by means of large circles or by parallel circles of the dome 52, so that the dome 52 can be completely filled with such partial surfaces 58 and 60.

However, the delimiting with large circles and parallel circles in the example shown in FIG. 2 can only be carried out exclusively through control of the scanning head 46 when the panorama projectors with the light deflection of the scanning head are located precisely in the center. However, because of the starball 50, there is no room available in the center and the panorama projectors 54 and 56 are arranged outside of the center. In this case, there are small overlaps in the edge regions of the scanned surfaces. These overlapping regions due to excessively large scanned surfaces are avoided in that the light intensity of the light bundle 10 is reduced by means of the modulators 26, 28, 30 when the partial surfaces 58 and 60 are exceeded.

FIG. 3 is a schematic view of the arrangement of scanning heads 46 of planet projectors 51 in the vicinity of a starball 50. A frame on which the starball 50 is arranged so as to be rotatable in the dome 52 is designated by 62. The center of the starball is identical to the center of the dome in order to carry out the rotating movement.

As is shown in FIG. 2 by their different orientation, the scanning heads 46 are movable by two angles so that the image of every planet projector 51 can be projected on different locations of the dome. Coupling to the light source 12 is also effected in this case by the light-conducting fiber 36 which was described more fully with reference to FIG. 1.

The individual planets can be moved on the dome 52 in conformity to the laws of celestial mechanics by means of the scanning heads 46. For this purpose, programmed sequences are provided in an associated movement mechanism, for example, the movement of a projected image on the dome 52 in the form of epicycloids.

FIG. 4 is a schematic view of a control device 64 which controls all of the processes in the planetarium. The core of this control device is a computer which calculates the planetary positions for different days, angular degrees and the like parameters which are to be displayed on the dome 52 and drives the movement mechanism 66 of a planet projector 51 in accordance with these parameters. The movement mechanism 66 itself contains a microprocessor so that preprogrammed movements can also be carried out in accordance with celestial mechanics. For this purpose, only the orbit parameters are given to the movement mechanism 66 by the control device 64, wherein the movement mechanism 66 then guides the image of a planet on its path over the dome of the planetarium by means of its own microprocessor control unit.

Further, the control device 64 controls the image contents by modulating the light source 12, whose light bundle 10 is guided to the scanning head 46 via the light-conducting fiber 36. Further, the control device 64 also controls the image contents of dome projections by means of a plurality of panorama projectors, only one of which 54 is shown schematically in this case.

The computer in the control device 64 generates not only images in the planetarium, but also provides for a corresponding rectification by means of a distortion of the images which counteracts a distortion of the images on the dome due, for example, to the fact that the panorama projectors 54, 56, especially their scanning devices 40, are not arranged in the center of the dome 52.

Further, the control device 64 also emits signals so that the light bundles 10 used for projection are blanked in the surface areas that are accessible to the scanning heads 46 of the panorama projectors 54 and 56 and which exceed the desired partial surfaces 58 and 60.

1. Device for projection on a dome with a plurality of projectors (50, 51, 54, 56) for displaying image contents on an at least partially spherical projection surface (52), wherein every projector (50, 51, 54, 56) is arranged in such a way that it illuminates at least a partial surface (56, 58) of the projection surface (52) with partial images, and wherein there is provided for at least for one of the projectors (51, 54, 56) a light source (12) and a deflecting device (40) by which a light bundle (10) emitted from the light source (12) can be guided along the portion to be illuminated in order to display the image contents, characterized in that the deflecting device (40) of the at least one projector (51, 54, 56) is constructed as a scanning device by which the light bundle (10) can be guided in a plurality of lines with a plurality of picture points over the partial surface (56, 58) to be illuminated, and the light source (12) is connected to an intensity control (64) on the basis of which individual picture points can be illuminated for displaying the partial image (56, 58) with suitable luminous density.

2. Device according to claim 1, characterized in that a projector located in the center of the dome is a starball (50) for projecting the starry sky.

3. Device according to claim 2, characterized in that the scanning devices (40) of a plurality of projectors (54, 56) having the light source (12), the scanning device (40) and the intensity control are arranged concentrically around the starball (50) and/or in the vicinity of its periphery, wherein a plurality of polygonal partial surfaces can be illuminated by these projectors (54), these polygonal partial surfaces being bordered on at least two sides by segments of large circles and/or parallel circles of the dome (52).

4. Device according to one of claims 1 to 3, characterized in that a plurality of partial surfaces (58, 56) can be illuminated by a plurality of these projectors (54, 56) with scanning devices (40), in that at least one of these projectors (54, 56) has at least one scanning device (40) which enables the illumination of a region of the projection surface which is larger than the partial surface (58, 60) to be illuminated by this projector (54, 56), and in that the light source (12) can be blanked by means of the intensity control (64) when scanning in the larger region outside of the partial surface (58, 60) to be illuminated.

5. Device according to one of claims 1 to 4, characterized in that a light-conducting fiber (36) is provided between the scanning device (40) and the light source (12) and a movement device (66) is provided by which the scanning device (40) is movable independently from the light source (12).

6. Device according to claim 5, characterized in that the movement device (66) is equipped for tilting movements independent in at least two directions.

7. Device according to one of claims 5 or 6, characterized in that the movement device (66) is controllable by means of a control device (64) for at least one programmed movement sequence of the partial image illuminated by the at least one projector (51).

8. Device according to claim 7, characterized in that movements of partial images (58, 60) on the projection surface (52) can be carried out on the basis of programmed movement sequences in large circles or for theoretically calculated planetary orbits.

9. Device according to one of claims 1 to 8, characterized in that the light source (12) of the at least one projector (51, 54, 56) outfitted with a scanning device (40) is controllable for a color display of the partial image (58, 60) for emitting a light bundle (10) containing light with at least three different wavelengths.

10. Device according to claim 9, characterized in that the light source (12) for emitting the light bundle (10) containing light with at least three different wavelengths has a laser (20, 22, 24) for each of these wavelengths, each laser (20, 22, 24) being connected to a control device (64) for controlling intensity, by means of which the color of the light bundle (10) can be controlled for different image points of the partial surface (58, 60).
